(19) United States
(12) Patent Application Publication
(10) Pub. No.: US 2011/0087726 A1
(43) Pub. Date: Apr. 14, 2011

(54) CLOUD SERVER, CLIENT TERMINAL, DEVICE, AND METHOD OF OPERATING CLOUD SERVER AND CLIENT TERMINAL

(75) Inventors: Eok-soo SHIM, Suwon-si (KR); Byung-woan KIM, Seoul (KR); Kyoung-heun SHIN, Yongin-si (KR); Kyung-ah CHANG, Seoul (KR)

(73) Assignee: SAMSUNG ELECTRONICS CO., LTD., Suwon-si (KR)

(21) Appl. No.: 12/819,771

(22) Filed: Jun. 21, 2010

(30) Foreign Application Priority Data
Oct. 14, 2009 (KR) 10-2009-0097949

(51) Int. Cl. G06F 15/16

(52) U.S. Cl. 709/203; 709/245

(57) ABSTRACT

A cloud computing system that allows a client terminal to make use of different types of devices using a cloud computing service of a cloud server, is provided. The cloud server retrieves a virtual device driver for a device using retrieval information received from the client terminal and installs the virtual device driver so that the client terminal may control the device. Although the client terminal does not support an information format which is supported by the device, the computing service allows information to be used by the client terminal.

### CROSS REFERENCE TO RELATED APPLICATION(S)

This application claims the benefit under 35 U.S.C. §119(a) of Korean Patent Application No. 10-2009-0097949, filed on Oct. 14, 2009, the entire disclosure of which is incorporated herein by reference for all purposes.

### BACKGROUND

1. Field

The following description relates to a cloud computing system wherein a client terminal having limited resources makes use of resources provided by a cloud server.

2. Description of the Related Art

Cloud computing is an Internet-based computer technology. The term cloud is used as a metaphor for the Internet, based on the cloud drawing used to depict the Internet as an abstraction of the underlying infrastructure it represents. Cloud computing refers to a supplement, consumption, and delivery model for Internet-based IT services. With cloud computing, users no longer need knowledge of, expertise in, or control over the technology infrastructure that supports the services they use over the Internet.

Cloud computing provides the user with computing resources over the Internet anytime, anywhere. Examples of cloud computing resources that are typically managed by resource providers such as data centers, include a central processing unit (CPU), capacity, memory, storage, development platforms, application programs, and the like. Cloud computing services are provided by resource providers to make more efficient use of computing performance on terminals.

### SUMMARY

In one general aspect, there is provided a cloud server including a communication unit for receiving from a client terminal a request for a computing service that allows the client terminal to use a device that executes information including services executed by the cloud server, which are desired by the client terminal, a virtual device driver manager for retrieving a virtual device driver for the device based on the computing service request, and a computing service provider for using the virtual device driver to provide the computing service to the client terminal.

The virtual device driver manager may install the virtual device driver in the computing service provider.

After the virtual device driver is installed, the computing service provider may provide a control device driver and a virtual interface, the control device driver converts information to be transmitted from the client terminal to the device into a format that is capable of being processed by the device, and the virtual interface allows a user of the client terminal to use the client terminal to transmit the information to the device.

The computing service provider may provide an application as the computing service that is executed on the computing service provider, to the client terminal, through the communication unit, in response to the client terminal selecting data used on the application as information to be sent to the device, the selected data may be provided to the control device driver, and the control device driver may convert the data into a format that is capable of being processed by the device.

The cloud server may further include a storage for storing a plurality of virtual device drivers therein, wherein the virtual device driver manager retrieves a virtual device driver for the device from the storage.

In response to the communication unit receiving retrieval information from the client terminal, the virtual device driver manager may use the retrieval information to retrieve the virtual device driver from the storage.

If the retrieval information is an IP address of the device, the virtual device driver manager may control the communication unit to acquire device information about the device by communicating with the device using the IP address, and may retrieve a virtual device driver for the device from the storage using the device information.

If the retrieval information is device identification information, the virtual device driver manager may retrieve a virtual device driver for the device from the storage using the device identification information.

In another aspect, there is provided a client terminal including a controller to acquire retrieval information for a cloud server that provides a computing service that allows a client terminal to use a device that executes information desired by the client terminal, and to retrieve a virtual device driver for the device which converts the information needed by the client terminal into a format that is capable of being processed by the device, and a communication unit transmitting the retrieval information to the cloud server.

The information to be executed by the device may include at least one of data and control information.

The retrieval information may be an IP address.

The retrieval information may be identification information of the device.

The client terminal may further include a display outputting display information, wherein the controller controls the display to display information about at least one of a virtual interface and an application provided by the cloud server.

The client terminal may further include a user interface to receive a user input signal that determines information to be executed by the device.

The communication unit may include a first communication module to communicate with the cloud server, a second communication module to communicate with the device, and a communication relay module to convert information received through the first communication module into a format that is capable of being processed by the second communication module.

In another aspect, provided is a device including a communication unit to receive information to be executed by the device from at least one of a client terminal and a cloud server that provides a computing service that allows the client terminal to use the device that executes information desired by the client terminal, and an execution unit to convert the information into a format that is capable of being processed by the device, and to execute the converted information.

The device may further include a device driver supporting additional conversion that is used to execute the converted information on the execution module.

The information to be executed by the device may include at least one of data and control information.

In another aspect, there is provided a method of operating a cloud server, the method including receiving, from a client terminal, a request for a computing service that allows the client terminal to use a device that executes information desired by the client terminal, retrieving a virtual device driver for the device according to the computing service request, and using the virtual device driver to provide the computing service to the client terminal so that the client terminal may make use of the device.

In another aspect, there is provided a method of operating a client terminal, the method including acquiring retrieval information for a cloud server that provides a computing service allowing the client terminal to use a device that executes information desired by the client terminal, retrieving a virtual device driver for the device which converts the information desired by the client terminal into a format that is capable of being processed by the device, and transmitting the retrieval information to the cloud server.

Other features and aspects may be apparent from the following description, the drawings, and the claims.

### BRIEF DESCRIPTION OF THE DRAWINGS

FIG. 1 is a diagram illustrating an example of a client terminal that makes use of different kinds of devices using a cloud computing service.

FIG. 2 is a diagram illustrating another example of a client terminal that makes use of different kinds of devices using a cloud computing service.

FIG. 3 is a diagram illustrating an example of a cloud server.

FIG. 4 is a diagram illustrating an example of a client terminal.

FIG. 5 is a diagram illustrating an example of a communication unit of a client terminal.

FIG. 6 is a diagram illustrating an example of a virtual interface of a client terminal.

FIG. 7 is a diagram illustrating an example of a device that executes information for a client terminal.

FIG. 8 is a flow chart illustrating an example of a method performed by a cloud server.

FIG. 9 is a flow chart illustrating an example of a method performed by a client terminal.

Throughout the drawings and the description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

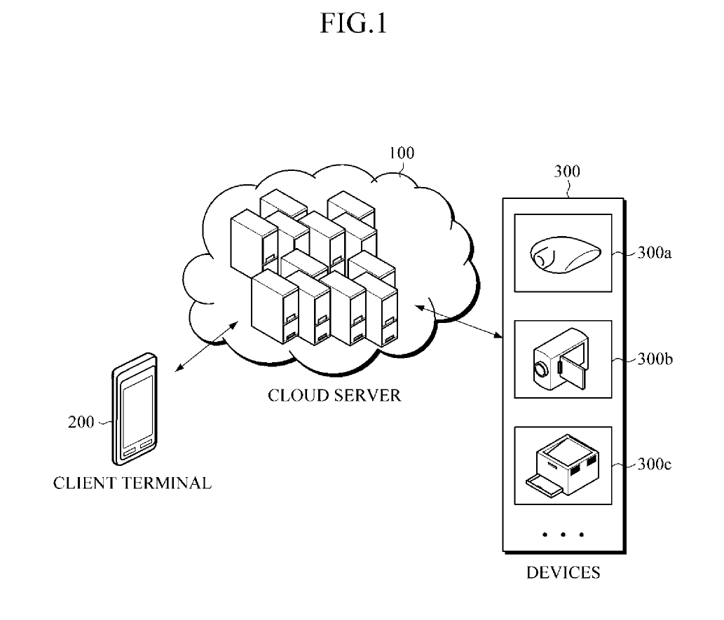

FIG. 1 illustrates an example of a client terminal that makes use of different kinds of devices using a cloud computing service.

Referring to FIG. 1, cloud server 100 provides a client terminal 200 with a cloud computing service (hereinafter referred to as “computing service”). That is, the cloud server 100 provides the client terminal 200 with computing resources through the Internet. For example, the cloud server 100 may provide the client terminal 200 with a computing service which allows the client terminal 200 to make use of a device 300.

The client terminal 200 refers to a user terminal that allows a user to receive a computing service. The client terminal 200 may communicate with the cloud server 100. Examples of the client terminal 200 include a personal digital assistant (PDA), a mobile terminal, a portable media player (PMP), an MP3 player, a digital camera, and the like. The client terminal 200 may typically be a CE-based mobile device with limited computing performance.

The device 300 is an electronic device executing information that the client terminal 200 desires. Examples of the information may include a variety of data, such as moving images, multimedia content, text, and the like. The information may be control information, such as commands to control the device 300. As shown in FIG. 1, examples of the device 300 may include electronic devices, such as a projector 300a, a camcorder 300b, and a printer 300c.

Referring to FIG. 1, for example, the cloud server 100 may be connected to the client terminal 200 and the device 300 through the Internet. The cloud server 100 receives, from the client terminal 200, retrieval information necessary for retrieving a virtual device driver of the device 300. The retrieval information may be included in computing service request information of the client terminal 200. For example, the retrieval information may be received by the cloud server 100 through a message transmitted after the computing service request information is sent.

The retrieval information may include an Internet Protocol (IP) address assigned to the device 300. The cloud server 100 may communicate with the device 300 through the IP address of the device 300 to acquire information about the device 300. The cloud server 100 may retrieve the virtual device driver of the device 300 using the device information and may install the virtual device driver on the cloud server 100 so that the client terminal 200 may control the device 300 through the cloud server 100.

The virtual device driver is a device driver of the device 300 which may be provided by the cloud server 100. The virtual device driver supports a computing service which allows the client terminal 200 with limited computing performance to make use of the device 300. In this example, the device 300 is for executing information that the client terminal 200 desires. For example, once the virtual device driver is installed on the cloud server 100, the information requested by the client terminal 200 may be converted into a format which may be processed by the device 300. A user of the client terminal 200 may be provided with a virtual interface so that the user may send information which is to be executed by the device 300.

The cloud server 100 may directly control the device 300 at the request of the client terminal 200 and provide the client terminal 200 with the control result of the device 300.

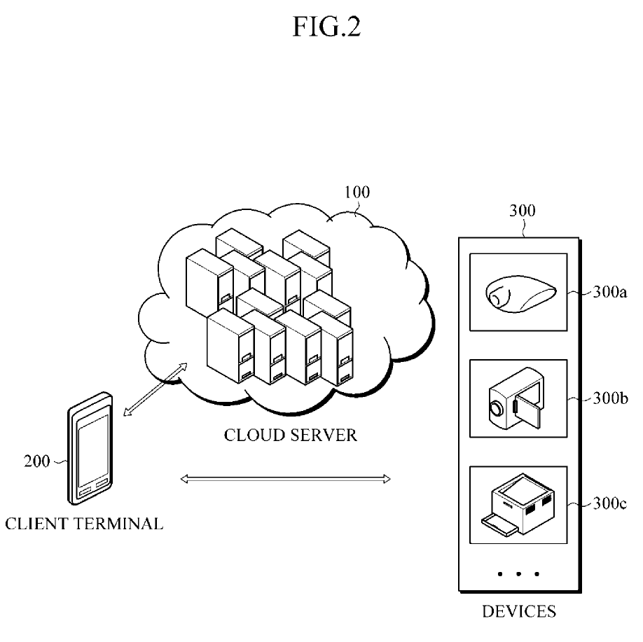

FIG. 2 illustrates another example of a client terminal that makes use of different kinds of devices using a cloud computing service.

The environment shown in FIG. 2 is similar to the environment shown in FIG. 1, however, in this example the device 300 does not establish IP communication but establishes communication in compliance with another communication protocol, such as Bluetooth or an infrared communication protocol. In this example, the cloud server 100 may use the virtual device driver to assist the client terminal 200 in making use of the device 300.

However, if the device 300 cannot establish IP communication directly, the cloud server 100 may not be able to directly transmit information that the client terminal 200 desires to the device 300. In this example, the client terminal 200 may serve to transmit the information to be executed on the device 300 to the device 300. Accordingly, the client terminal 200 may serve as a communication hub between the cloud server 100 and the device 300.

The cloud server 100 may use the virtual device driver of the device 300 to convert the information executed on the device 300 into a format which may be processed by the device 300. The cloud server 100 may transmit the converted information to the client terminal 200. The client terminal 200 may transmit the converted information to the device 300 by any available protocol for communication with the device 300.

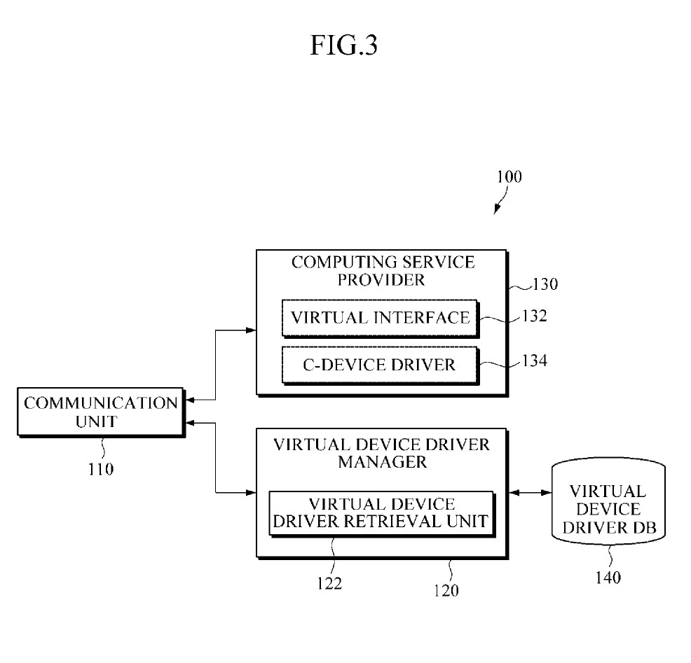

FIG. 3 illustrates another example of a cloud server.

Referring to FIG. 3, cloud server 100 includes a communication unit 110, a virtual device driver manager 120, a computing service provider 130, and a virtual device driver database (DB) 140.

The communication unit 110 is configured to communicate with the client terminal 200 using the Internet Protocol. Also, the communication unit 110 may communicate with the device 300 if the device 300 establishes communication using the Internet Protocol.

The virtual device driver manager 120 manages a virtual device driver for the device 300. The virtual device driver manager 120 may include a virtual device driver retrieval unit 122 which retrieves a virtual device driver.

The virtual device driver retrieval unit 122 may receive retrieval information of the virtual device driver from the client terminal 200 through the communication unit 110. The virtual device driver retrieval unit 122 may use the retrieval information to retrieve the virtual device driver for the device 300. The virtual device driver retrieval unit 122 may retrieve a virtual device driver for the device 300 from the virtual device driver DB 140 that stores virtual device drivers for various kinds of devices therein. The virtual device driver retrieval unit 122 may install the virtual device driver in the computing service provider 130 of the cloud server 100.

In some embodiments, the virtual device driver DB 140 and the virtual device driver manager 120 may be included in a single entity. In the example shown in FIG. 3, the virtual device driver retrieval unit 122 is included in the virtual device driver manager 120. However, in some embodiments, the computing service provider 130 that provides a computing service to the client terminal 200 may be configured to retrieve the virtual device driver.

Hereinafter, a process whereby the virtual device driver retrieval unit 122 retrieves a virtual device driver for the device 300 is described. The retrieval process is discussed with reference to FIG. 1. As discussed with reference to FIG. 1, the device 300 may communicate with the cloud server 100.

The virtual device driver manager 120 may receive retrieval information about the device 300 from the client terminal 100. The retrieval information may include, for example, and IP address. In this example, the IP address of the device 300 indicates a fixed IP address only for a corresponding device 300.

The retrieval information about the device 300 may be included in a device registration request message. The registration of the device 300 may be a process before retrieval of the virtual device driver for the device 300.

The virtual device driver manager 120 may access the device 300 using the IP address, through the communication unit 110, and acquire the device information. A process by which the virtual device driver manager 120 accesses the device 300 through the communication unit 110 to acquire the device information may be performed by various methods known in the art.

The device information is used in retrieving the virtual device driver. Examples of the device information may include device identification information such as a device model code. The virtual device driver retrieval unit 122 may use the device information to retrieve a virtual device driver for the device 300. The virtual device driver may be retrieved from the virtual device driver DB 140.

The process of retrieving the virtual device driver is discussed with reference to FIG. 2. In the example shown in FIG. 2, the device 300 does not directly communicate with the cloud server 100.

Instead, the virtual device driver manager 120 may receive device identification information, as retrieval information from the client terminal 200, through the communication unit 110. The virtual device driver retrieval unit 122 may use the device identification information to retrieve a virtual device driver from the virtual device driver DB 140.

After the virtual device driver is retrieved, the virtual device driver manager 120 may install the virtual device driver in the computing service provider 130.

The computing service provider 130 provides a computing service to the client terminal 200. The computing service provider 130 may be a computing service provided from the cloud server 100 to the client terminal 200 or a user instance in terms of a computing service to the client terminal 200. However, the virtual device driver does not need to be registered with a user instance prepared for the client terminal 200. Instead, the virtual device driver may be installed in another user instance and operated so as to provide any functionality desired by a user of the client terminal 200.

The virtual device driver as well as applications to be provided to the client terminal 200 for computing services may be registered with the computing service provider 130. Display information about application operation and/or information about interaction with the client terminal 200 may be provided to the client terminal 200. The applications may be multimedia content playback programs. In this example, the cloud server 100 may serve as a streaming server.

If the virtual device driver is installed in the computing service provider 130, a control-device driver (hereinafter referred to as “C-device driver”) and a virtual interface may be provided. Referring to FIG. 3, the virtual interface 132 and the C-device driver 134 are used to indicate that the virtual device driver for the device 300 is installed in the computing service provider 130.

The user of the client terminal 200 may input information to be sent to the device 300 through the virtual interface 132. The virtual interface 132 may be provided to receive control information, such as commands that are to be executed by the device 300. The virtual interface 132 may be provided to select and receive data to be sent to and to be executed by the device 300. For example, the virtual interface 132 may be a graphical user interface which is displayed when a computer transmits data through a cable to a device connected to the computer, for example, when a terminal transmits video data to a television through a cable connected to an external terminal thereof. A user may of the client terminal 200 may use the virtual interface 132 to select and send data.

The C-device driver 134 has general data transmission functionality and data format conversion functionality.

The general data transmission functionality corresponds to data transmission functionality based on the type and/or the form of the device 300, such as a printer or a projector.

To perform data format conversion, the C-device driver 134 may include information about the device 300, such as resolution of the device 300 and useable file format. The C-device driver 134 may use the information about the device 300 to convert information requested by the client terminal 200 into a format which may be processed and executed by the device 300. The information executed on the device 300 may include control information and/or data.

If control information is received as the information to be executed on the device 300, using the virtual interface 132, the C-device driver 134 may convert the control information into control information which may be processed by the device 300. If data is received as the information to be executed on the device 300, the C-device driver 134 may convert the data into data which may be processed by the device 300.

For example, if the information to be executed on the device 300 is control information, and the device 300 is a display processing a remote control input signal, the C-device driver 134 may convert a turn-on signal for turning on the display. The turn-on signal may be converted into a remote control input signal for turning on the display. If the information to be executed on the device 300 is data, for example, the C-device driver 134 may convert GIF (Graphics Interchange Format) data into JPEG (Joint Photographic Experts Group) data.

The C-device driver 134 may be operated in association with an application to be provided as a computing service to the client terminal 200. For example, the computing service provider 130 may provide an application as a computing service to the client terminal 200 through the communication unit 110. The application may be executed on the computing service provider 130. If the client terminal 200 selects data used on the application as information to be sent to the device 300, the selected data may be transmitted to the C-device driver 134. The C-device driver 134 may convert the selected data into a format which may be processed by the device 300.

For example, if the device 300 is recognized by a text editing program as a text application, and the client terminal 200 requests a text file which is executed by the text editing program, the text file may be processed and converted by the C-device driver 134 into data which may be processed by the device 300, and may be transmitted to the device 300.

Conversely, if the device 300 cannot establish IP communication as discussed with reference to FIG. 2, the information which is processed by the C-device driver 134 and that is to be executed by the device 300 may be sent to the device 300 through the client terminal 200.

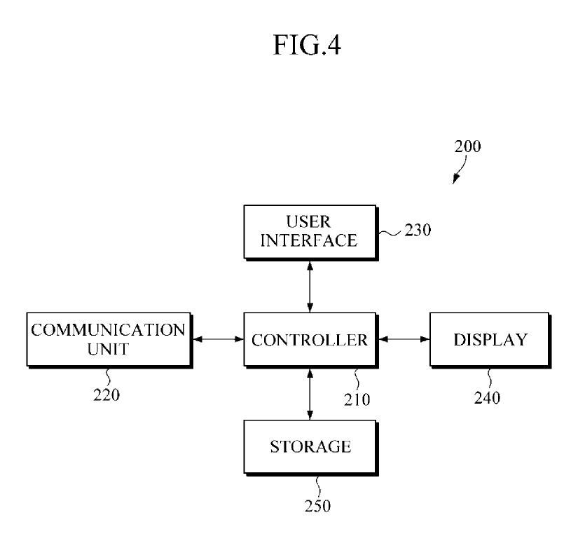

FIG. 4 illustrates an example of a client terminal.

Referring to FIG. 4, client terminal 200 includes a controller 210, a communication unit 220, a user interface 230, a display 240, and a storage 250.

The controller 210 controls general operations of the client terminal 200. The controller 210 may have limited computing performance necessary for the operation of the client terminal 200. The controller 210 may be operated to use a computing service provided by the cloud server 100 that is connected through the Internet.

The communication unit 220 may be configured to establish communication with the cloud server 100. Also, the communication unit 220 may be configured to communicate with the device 300, if the device 300 cannot establish IP communication using other protocols, such as Bluetooth or infrared communication protocol.

The user interface 230 receives and sends a user input signal to the controller 210. Examples of the user interface 230 may include a touch screen, a touch pad, a key pad, a jog wheel, and the like.

The display 240 outputs display information provided by the controller 210.

The storage 250 may store an operating system, an application, data, and the like, to be executed by the controller 210.

The controller 210 may acquire retrieval information that the cloud server 100 may use to retrieve a virtual device driver for the device 300. The virtual device driver converts information desired by the client terminal 200 into a format that may be processed by the device 300, through the second communication module 226.

The retrieval information may be entered through the user interface 230. When the storage 250 stores retrieval information about different types of devices therein, the controller 210 may control the display 240 to display the retrieval information about the different types of devices. That is, a user may select retrieval information about the user's desired device 300 using the displayed retrieval information. For example, the retrieval information may be an IP address or identification information of the device. Also, the retrieval information may be any kind of information which may be used by the cloud server 100 to retrieve a virtual device driver corresponding to the device 300.

Once the controller 210 acquires the retrieval information, the communication unit 220 sends the retrieval information to the cloud server 100. The cloud server 100 uses the retrieval information to retrieve and install a virtual device driver. Accordingly, the cloud server 100 may provide the client terminal 200 with a virtual interface and/or display information about an application requested by the client terminal 200. The cloud server 100 may also provide information about interaction with the client terminal 200. The virtual interface, the display information about the application, and/or the interaction information, which are provided by the cloud server 100, may be received through the communication unit 220. The controller 210 may control the display 240 to display the received display information.

Accordingly, once the cloud server 100 installs the virtual device driver to provide a cloud computing service, the user may view the application, the display information of the virtual interface, and/or the information about interaction with the client terminal 200, which are displayed on the display 240. The user may use the display information to select and transmit data and/or control information to be executed by the device 300. The information executed on the device 300 may be information stored in the cloud server 100 and/or the client terminal 200.

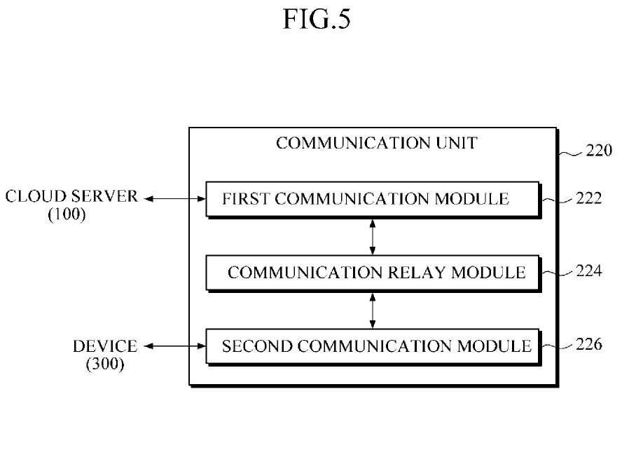

FIG. 5 illustrates an example of a communication unit of a client terminal.

If the device 300 cannot establish communication with the cloud server 100, as discussed with reference to FIG. 2, the communication unit 220 may be configured to establish IP communication with the cloud server 100 using an Internet Protocol. For example, the communication unit 220 may establish communication with the device 300 using any available protocol, such as Bluetooth or an infrared communication protocol, to enable communication therebetween.

Referring to FIG. 5, the communication unit 220 includes a first communication module 222, a communication relay module 224, and a second communication module 226.

The first communication module 222 establishes communication with the cloud server 100. The second communication module 226 establishes communication with the device 300. The second communication module establishes connection according to a different communication protocol, in comparison to the first communication module 222. The communication relay module 224 may convert information received through the first communication module 222 into a format which may be processed by the second communication module 226. For example, the communication relay module 224 may receive a packet including data which may be processed by the device 300, extract the data from the packet, convert the data into a format complying with a communication protocol which may be used by the device 300, and transmit the converted data to the device 300.

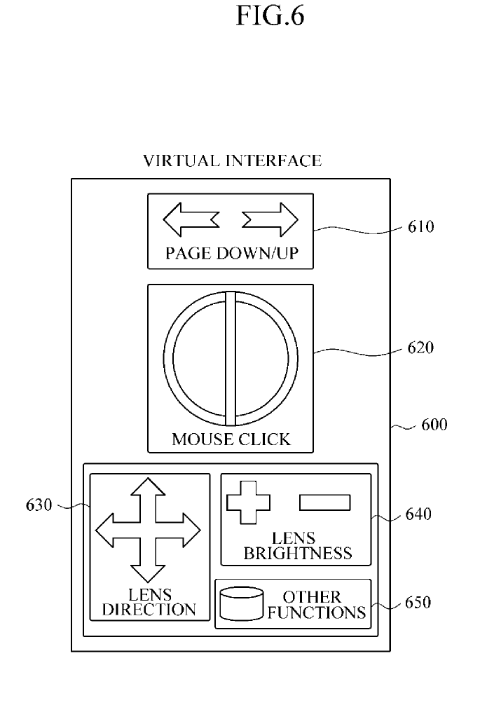

FIG. 6 illustrates an example of a virtual interface of a client terminal.

Referring to FIGS. 1, 4, and the example shown in FIG. 6, a virtual interface is provided on the display 240 of the client terminal 200, after the cloud server 100 retrieves and installs a virtual device driver for the device 300. In this example the device 300 is a projector. Accordingly, a virtual interface 600 for selecting control items for controlling the projector, such as page down/up 610, mouse click 620, lens direction 630, lens brightness 640, and other functions 650, may be displayed on the display 240 of the client terminal 200.

The user may use the user interface 230 to select one of the control items displayed on the virtual interface 600, for example, by touching a touch screen or using a direction key on a key pad. The user may use the user interface 230, for example, to select page down/up 610, click on “Next Page” with a mouse to perform a corresponding operation on the device 300, and the like. Further, the user may select the lens direction 630 to move a lens mounted on the device 300 or select the lens brightness 640 to control the brightness of the lens.

The selected control item and execution information for the control item may be transmitted to the cloud server 100. The cloud server 100 may convert the selected control item and execution information for the control item into information that may be processed by the device 300. Also, the cloud server 100 may transmit the converted information to the device 300. The device 300 may execute the converted information to perform an operation corresponding to the control item and execution information which are requested by the client terminal 200.

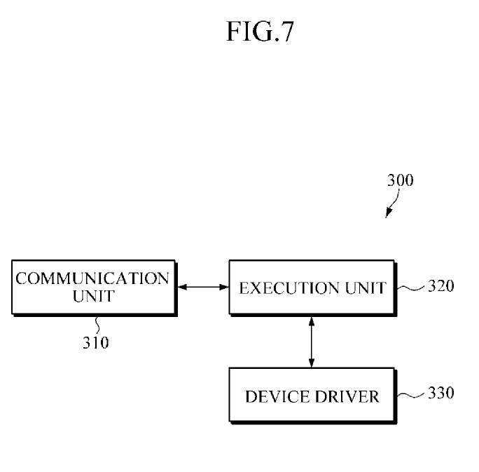

FIG. 7 illustrates an example of a device that executes information for a client terminal.

Referring to FIG. 7, device 300 includes a communication unit 310, an execution unit 320, and a device driver 330.

The communication unit 310 receives information to be executed on the device 300 from the cloud server 100 and/or the client terminal 200. The communication unit 310 may be configured to establish IP communication with the cloud server 100. Alternatively, the communication unit 310 may be configured to establish communication with the client terminal 200 so as to receive the information from the cloud server 100 through the client terminal 200.

In some embodiments, the communication unit 310 may be configured to establish IP communication with the cloud server 100, and the communication unit 310 may be configured to simultaneously establish communication with the client terminal 200 so as to receive the information from the cloud server 100 and from the client terminal 200.

The execution unit 320 converts information into a format which may be executed by the device 300 and executes the converted information. For example, the execution unit 320 may convert the information received from the cloud server 100 or the client terminal 200 into an electrical signal or another format which may be executed by the device 300, and execute the converted information. For example, if the device 300 is a display which receives and executes a remote control input signal, and information received from the cloud server 100 or the client terminal 200 is control information, the execution unit 320 may convert the control information into the remote control input signal.

If at least one of the converted control information and data needs to be converted to be executed by the execution unit 320, the device driver 330 may support such conversion. For example, if the device 300 is a server printer, the device driver 330 may further process the information received from the cloud server 100 or the client terminal 200.

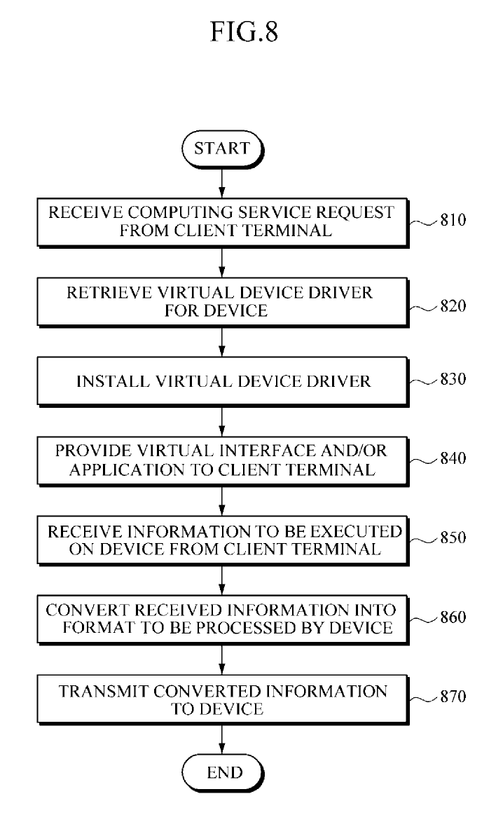

FIG. 8 illustrates an example of a method performed by a cloud server.

Referring to FIG. 8, in 810, the cloud server receives a request for a computing service from the client terminal 200. The computing service allows the client terminal to use the device executing information desired by the client terminal. Upon receipt of the computing service request, retrieval information used to retrieve a virtual device driver for the device may be received from the client terminal.

In 820, upon receipt of the computing service request, the cloud server retrieves the virtual device driver for the device using the retrieval information. In 830, the cloud server installs the retrieved virtual device driver.

In 840, an application, a C-device driver, and a virtual interface for cloud service stored on the cloud server, are provided to the client terminal.

In 850, information to be executed by the device is received from the client terminal using the application and/or the virtual interface. In 860, the C-device driver of the cloud server converts the information into a format which may be processed by the device. In 870, the cloud server sends the converted information to the device. As discussed above, the converted information may be sent to the device through the client terminal.

Accordingly, the computing server may assist a client terminal that is capable of accessing the Internet by overcoming limited computing performance thereof. For example, the computing server may assist the client terminal in using the device without the need to upgrade the client terminal to support data formats, codecs, device controls, and the like, which the client terminal does not support, or without the need to change protocols to support the data format.

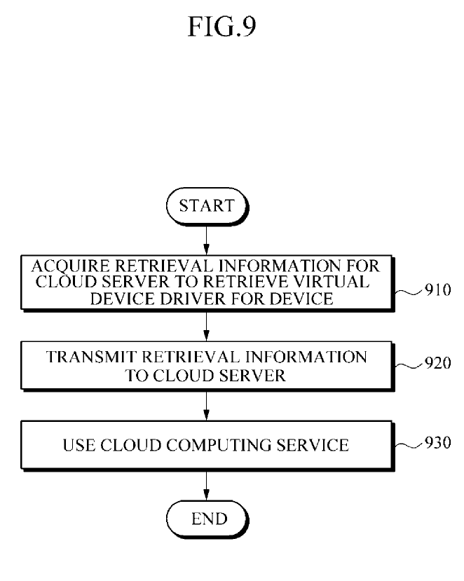

FIG. 9 illustrates an example of a method performed by a client terminal.

Referring to FIG. 9, in 910, the client terminal acquires retrieval information that the cloud server may use to retrieve the virtual device driver for the device. In 920, the client terminal sends the retrieval information to the cloud server.

In 930, because the cloud server installs the virtual device driver for the device using the retrieval information, the client terminal may use the computing service which is provided by the cloud server. For example, the client terminal may determine the information to be executed on the device using an application and/or a virtual interface provided as the computing service. The cloud server converts the information executed on the device into a format which may be processed by the device.

Alternatively, if the information to be transmitted from the cloud server to the device and to be executed by the device is converted into the format which may be processed by the device and is received by the client terminal, the client terminal may convert the received information to comply with a communication protocol of the device and transmit the converted information to the device.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cloud server, comprising:
a communication unit configured to receive from a client terminal a request for a computing service that allows the client terminal to use a device that executes information including services executed by the cloud server, which are desired by the client terminal;
a virtual device driver manager configured to retrieve a virtual device driver for the device based on the computing service request; and
a computing service provider configured to use the virtual device driver to provide the computing service to the client terminal.

2. The cloud server of claim 1, wherein the virtual device driver manager is further configured to install the virtual device driver in the computing service provider.

3. The cloud server of claim 2, wherein, after the virtual device driver is installed:
is the computing service provider is further configured to provide a control device driver and a virtual interface;
the control device driver converts information to be transmitted from the client terminal to the device into a format that is capable of being processed by the device; and
the virtual interface allows a user of the client terminal to use the client terminal to transmit the information to the device.

4. The cloud server of claim 2, wherein:
the computing service provider is further configured to provide an application as the computing service that is executed on the computing service provider, to the client terminal, through the communication unit,
in response to the client terminal selecting data used on the application as information to be sent to the device, the selected data is provided to the control device driver, and
the control device driver is further configured to convert the data into a format that is capable of being processed by the device.

5. The cloud server of claim 1, further comprising:
a storage configured to store a plurality of virtual device drivers therein,
wherein the virtual device driver manager retrieves a virtual device driver for the device from the storage.

6. The cloud server of claim 5, wherein, in response to the communication unit receiving retrieval information from the client terminal, the virtual device driver manager is further configured to use the retrieval information to retrieve the virtual device driver from the storage.

7. The cloud server of claim 6, wherein, if the retrieval information is an IP address of the device, the virtual device driver manager is further configured to:
control the communication unit to acquire device information about the device by communicating with the device using the IP address; and
retrieve a virtual device driver for the device from the storage using the device information.

8. The cloud server of claim 6, wherein, if the retrieval information is device identification information, the virtual device driver manager is further configured to retrieve a virtual device driver for the device from the storage using the device identification information.

9. A client terminal, comprising:
a controller configured to:
acquire retrieval information for a cloud server that provides a computing service that allows a client terminal to use a device that executes information desired by the client terminal; and
retrieve a virtual device driver for the device which converts the information needed by the client terminal into a format that is capable of being processed by the device; and
a communication unit configured to transmit the retrieval information to the cloud server.

10. The client terminal of claim 9, wherein the information to be executed by the device comprises at least one of data and control information.

11. The client terminal of claim 9, wherein the retrieval information comprises an IP address.

12. The client terminal of claim 9, wherein the retrieval information comprises identification information of the device.

13. The client terminal of claim 9, further comprising:
a display configured to output display information,
wherein the controller is further configured to control the display to display information about at least one of a virtual interface and an application provided by the cloud server.

14. The client terminal of claim 13, further comprising a user interface configured to receive a user input signal that determines information to be executed by the device.

15. The client terminal of claim 9, wherein the communication unit comprises:
a first communication module configured to communicate with the cloud server;
a second communication module configured to communicate with the device; and
a communication relay module configured to convert information received through the first communication module into a format that is capable of being processed by the second communication module.

16. A device, comprising:
a communication unit configured to receive information to be executed by the device from at least one of a client terminal and a cloud server configured to provide a computing service that allows the client terminal to use the device that executes information desired by the client terminal; and
an execution unit configured to:
convert the information into a format that is capable of being processed by the device; and
execute the converted information.

17. The device of claim 16, further comprising a device driver configured to support additional conversion that is used to execute the converted information on the execution module.

18. The device of claim 16, wherein the information to be executed by the device comprises at least one of data and control information.

19. A method of operating a cloud server, the method comprising:
receiving, from a client terminal, a request for a computing service that allows the client terminal to use a device that executes information desired by the client terminal;
retrieving a virtual device driver for the device according to the computing service request; and
using the virtual device driver to provide the computing service to the client terminal so that the client terminal may make use of the device.

20. A method of operating a client terminal, the method comprising:
acquiring retrieval information for a cloud server that provides a computing service allowing the client terminal to use a device that executes information desired by the client terminal;
retrieving a virtual device driver for the device which converts the information desired by the client terminal into a format that is capable of being processed by the device; and
transmitting the retrieval information to the cloud server.
